(19) United States
(12) Patent Application Publication
(10) Pub. No.: US 2025/0101650 A1
(43) Pub. Date: Mar. 27, 2025

(54) PROCESS AND APPARATUS FOR FABRIC TREATMENT PROCESSING

(71) Applicant: Electronics for Imaging, Inc., Londonderry, NH (US)

(72) Inventors: Ivan Pagani, Grassobbio (IT); Paolo Maria Crippa, Grassobbio (IT); Massimiliano Papa, Grassobbio (IT); Giorgio Sala, Grassobbio (IT); Daniel Valota, Grassobbio (IT); Fabio Buelli, Grassobbio (IT)

(21) Appl. No.: 18/038,655

(22) PCT Filed: May 16, 2023
(86) PCT No.: PCT/US2023/022293

§ 371 Date: May 24, 2023

(30) Foreign Application Priority Data
May 25, 2022 (IT) 102022000010919

(51) Int. Cl. D06B 19/00; B41J 3/407; B41J 11/00; D06B 1/14; D06B 11/00; D06B 21/00

(52) U.S. Cl. CPC D06B 19/0005; B41J 3/4078; B41J 11/0015; D06B 1/14; D06B 11/0059; D06B 21/00

(57) ABSTRACT

A process for fabric treatment processing, comprising operating steps of printing a fabric (24), chemical finishing of the printed fabric (24) and drying/polymerization of the printed fabric (24), with said processing steps being implemented in-line with the fabric (24) transiting according to a horizontal advancing direction.

### CROSS REFERENCE TO RELATED APPLICATIONS

This application claims priority to Italian Patent Application No. 102022000010919 filed May 25, 2022 (25.05.22), which is incorporated herein by reference in its entirety.

### DESCRIPTION

The present invention relates to a process and to an apparatus for fabric treatment processing.

More particularly, the present invention relates to a process and to an apparatus functional for carrying out treatments on printed fabrics and, in particular, to finish or finishing treatments of a chemical type for the purpose of improving the appearance, the tactile quality, the colour, the physical properties, the elasticity, the breathability and similar other properties of the same fabrics, therefore, improving the quality of the final product.

As known, the so-called “ennobling” of a fabric involves printing and finish processing on the printed fabric.

The finish processing or finishing has the purpose of improving the appearance of the fabrics, the tactile quality, the colour, increasing mechanical properties such as, for example, the resistance to tearing or washing, elasticity and breathability and the like and, therefore, the finishing or finish has the function of improving the quality of the final product.

The finishing processing can be of the mechanical type (for example, calendering, pleating, brush-sueding etc.) functional to an increase in characteristics such as friction, resistance to temperatures and pressure, tension and the like or of the chemical type with the application of resins, aqueous solutions, silicones in the form of microfilms, plasma or enzyme treatments, etc., for improving characteristics such as, for example, waterproofing, softness, ability to resist dirt or stains, etc. or again, the finishing processing can be a mechanical-chemical combination.

Typically, the finishing processing is implemented on dedicated finishing machines or apparatuses in which the fabric is subjected to thermo-mechanical or chemical steps which, among other things, make it possible to increase the softness, solidity, intensity and colour space of the fabric.

Among the finishing machines or apparatuses, the so-called “Rameuse” are known, defined as machines which make the fabric, stretched and tensioned on rollers, slide through different areas (in variable numbers depending on the machine and the sought-after characteristics) and which comprise means for application of sizing or finishing, systems to ensure correct positioning of the fabric (a straightening and spreading unit), drying devices, pin systems (that is, special supports made up of interchangeable plates with rows of needles or teeth anchoring the fabric) which allow the sliding of the fabric through a drying chamber and towards the outlet area.

However, said known apparatuses have some significant drawbacks linked to the fact that they are dedicated apparatuses to be installed in the fabric processing plant and which involve considerable energy consumption.

A further drawback of traditional machinery and, in particular, of the above defined “Rameuse” is represented by the fact that the fabric that comes from the printing machine must be transferred to the finishing apparatus and this entails technical times linked to the transfer, to the preparation of the machine, to the inserting of the fabric into the machine and the like and all this entails correlated increases in production costs.

A further drawback is linked to problems of management of the physical spaces required for the additional apparatuses and to problems of surface consumption, meaning storage space for the semi-finished products.

A further drawback of said known apparatuses is represented by the maintenance costs.

A further drawback is represented by the management costs of said apparatuses which also contemplate higher costs of personnel dedicated to the management and control of said apparatuses.

A further and considerable drawback is linked to an inefficiency of the production chain between the printing process and the finishing process due to the different processing speeds and the different location areas of the dedicated apparatuses.

A further drawback of the known type of apparatuses is represented by the fact that they involve a double drying, that is, the fabric is subjected to a first drying step after the printing step and a second drying step following the finishing step; said operating procedure involves a considerable expenditure of energy, a consumption of chemical product and, consequently, an increase in the related costs.

The object of the present invention is to obviate the above drawbacks.

More specifically, the object of the present invention is to provide a process and a related apparatus for fabric treatment processing, with the apparatus being easy to install inside a fabric processing plant and which allows for a reduction in space necessary (and, therefore, also of the surface) for the allocation of the same apparatuses and for the storage of the semi-finished products.

A further object of the present invention is to provide an apparatus which allows a reduction in the amount of heat and, therefore, in the expenditure of energy in the printing and finish or finishing steps of the fabric.

A further object of the present invention is to provide an apparatus which allows a reduction in the amount of chemical product used in the finish processing or finishing. A further object of the present invention is to provide a finishing apparatus which is easy to maintain.

A further object of the present invention is to provide an apparatus which allows to contain the number of operators dedicated and involved in the working process and which, consequently, allows a containment of the related costs.

A further object of the present invention is to provide users with an apparatus and a process for finishing processing on fabrics capable of guaranteeing high resistance and durability over time and in such a way that it can be easily and inexpensively implemented.

These and other objects are achieved by the process and by the apparatus of the invention which has the characteristics set forth in claim 1.

According to the invention a process for fabric treatment processing comprising operating steps of printing a fabric, chemical finishing of the printed fabric and drying/polymerization of the printed fabric is provided, with said processing steps implemented in-line with the fabric transiting according to a horizontal advancing direction.

Advantageous embodiments of the invention are disclosed by the dependent claims. The constructive and functional characteristics of the process and of the apparatus for processing on fabrics and, in particular, for finishing processing on fabrics of the present invention can be better understood from the detailed description which follows, wherein reference will be made to the enclosed tables of drawings which represent a preferred and non-limiting embodiment thereof and wherein:

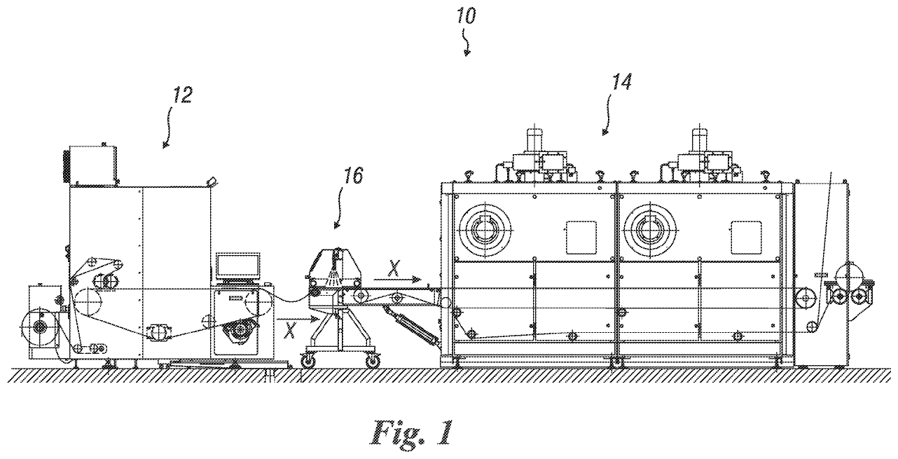

FIG. 1 schematically illustrates a side view of a plant for treating fabrics comprising the apparatus for finishing processing of the invention;

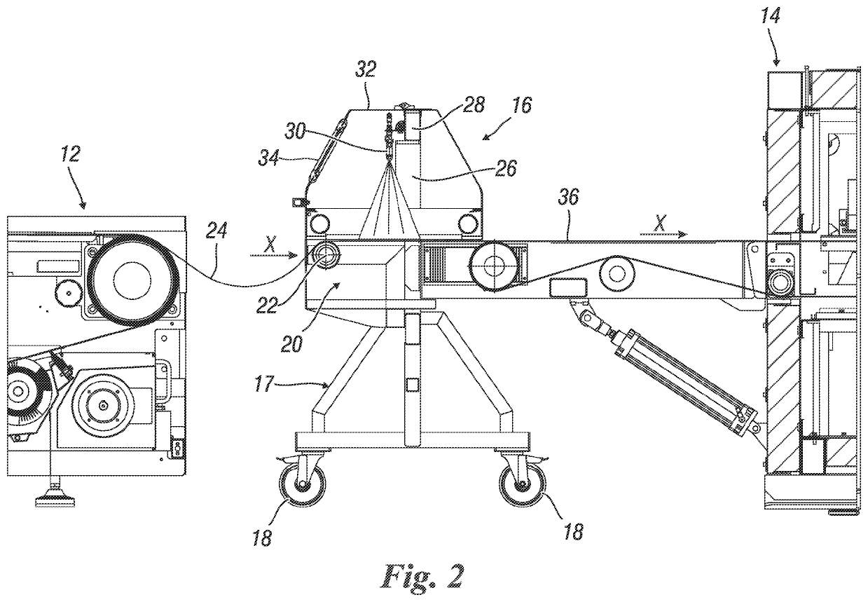

FIG. 2 schematically illustrates a side view of the apparatus for finishing processing on fabrics of the invention;

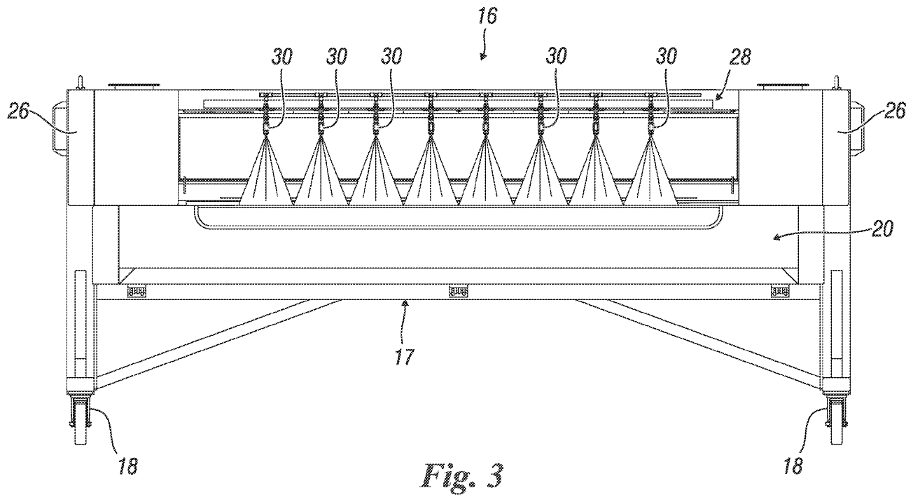

FIG. 3 schematically illustrates a front view of the apparatus for finishing processing of the invention.

With reference to the cited figures and, in particular, with reference to FIG. 1, a preferred and non-limiting embodiment is shown of a plant for processing on fabrics which comprises a printing device 12, a drying/polymerization device 14 and a finishing device 16 of the invention, with said three apparatuses arranged in-line. In the preferred embodiment shown in the figures, the finishing device 16 is arranged in an intermediate position between the printing device 12 and the drying/polymerization device 14.

However, according to alternative embodiments, the finishing device 16 can be arranged inside the drying/polymerization device 14 or externally to the same, but always in-line with the printing and drying/polymerization device.

The printing device 12, which is not described in detail since it is known, is of the type with pigment ink printing or of the type with digital printing or with another printing technique suitable for the function.

The drying/polymerization device, likewise not described in detail as it is known, comprises a chamber inside which the printed and treated fabric transits and in which said fabric is subjected to heat administration with temperatures ranging from 90° C. to 180° C. for a period of time comprised between 1 and 4 minutes and this in order to carry out the drying/polymerization process of the print on the fabric and, therefore, ennobling.

The finishing device 16 comprises a support structure 17 movable on wheels 18 (or fixed) designed to support a base 20 which transverse dimension substantially corresponds to the transverse development dimension of the printing device 12 and of the drying/polymerization device 14, said base 20 houses a drawing-in roller 22 rotatably arranged according to the transverse development direction of said base 20 and functional to allow the sliding of a fabric 24 as better detailed in the following. Stabilized on the base 20 is a pair of opposing and parallel shoulders 26 which support a crossbar 28 with respect with which means for applying a chemical solution to the fabric 24 in transit are integral.

According to the preferred embodiment shown in the figures, the means for applying a chemical solution comprise spraying elements comprising a plurality of spray nozzles 30 (as in the embodiment shown in the figures) arranged along the longitudinal development of the crossbar 28, equidistant from one another and arranged at the same height or at different heights; in an alternative embodiment the spraying elements can comprise at least one spray blade.

According to the preferred embodiment, the spray nozzles 30 are all arranged on the same side of the crossbar; however, according to an alternative embodiment, the spraying elements can comprise a different arrangement and be partially arranged on one side of the longitudinal development of the crossbar and partly on the opposite side or they can be arranged in several rows.

The application of the chemical solution, as well as by spraying, can also comprise a digital impregnation technique by means of dedicated heads implemented jointly with the spraying or as an alternative to the same.

According to alternative embodiments, the means for applying a chemical solution can comprise rollers impregnated with said solution and brought (by means of dedicated actuators, or by means of a lowering/raising movement of the crossbar 28) into contact with the surface of the fabric 24 to be subjected to the treatment.

According to further alternative embodiments, the means of applying a chemical solution to the fabric can be defined by one or more doctor blades or by the passage of the fabric 24 in a bath containing the chemical finishing solution.

Furthermore, according to alternative embodiments, the means of applying a chemical finishing solution to the fabric can comprise a sizing device with an impregnation tray. The structure of the crossbar 28 supported by the parallel and opposing shoulders 26 is covered by a protective casing 32 provided with a door 34 which can be opened for inspections and the like.

The process for processing a fabric by means of the apparatus of the invention comprises three macro-steps defined by a printing step, a chemical finishing treatment step and a drying/polymerization step.

The printing step of the fabric 24 (coming, for example, from a reel not shown), of the ink or digital type or made with another known technique, is implemented in the printing device 12 and said fabric 24 coming from the printing device 12 is drawn onto the drawing-in roller 22 of the finishing device 16 (arranged downstream of the printing device, with reference to the direction indicated by the arrow “X” in FIG. 1 and in FIG. 2) and pulled (at a fixed, variable or otherwise modulated speed, according to production requirements) by a mat 36 arranged downstream of said finishing device 12.

The fabric 24 drawn onto the roller 22 and pulled by the mat 36 transits under the crossbar 28 of the finishing device 16 and is subjected to the action of the nozzles 30 which spray the chemical solution (at variable flow rate) on the surface of said fabric according to a transverse development direction of the same; the advancement of the fabric 24 under the nozzles 30 allows a uniform distribution of the chemical solution over the entire surface of the same fabric with a uniform penetration of said solution into the fibres of the fabric.

The fabric 24 impregnated with the chemical solution in the finishing device 16 is moved, by means of the mat 36, into the drying/polymerization device 14 where, as previously described, said fabric is subjected to an administration of heat with temperatures ranging from 90° C. to 180° C. for a period of time comprised between 1 and 4 minutes and this in order to carry out the drying/polymerization process of the print on the same fabric.

The finishing step can be implemented after the step of drying/polymerization and, in said case, the finishing device 16 is arranged downstream and in the area of the outlet of the drying/polymerization device 14.

Alternatively, the finishing step can also be implemented during the drying/polymerization step with the finishing device 16 arranged inside the drying/polymerization device.

As can be seen from the foregoing, the advantages which the process for processing fabrics and the respective apparatus achieve are evident.

The apparatus of the invention advantageously allows to simplify the printing, finishing and drying/polymerization process of the fabric and this by virtue of the fact that the fabric treatment process is implemented in-line and, therefore, dedicated devices are not required (for example, a Rameuse type device) in order to transfer the printed fabric.

A further advantage of the apparatus of the invention is represented in that it allows to carry out a process characterized by a reduction in energy consumption per square meter of treated fabric; in fact, there is only one drying step of the fabric and this involves considerable energy savings with a related reduction in costs.

A further advantage is represented in that the apparatus of the invention allows an improved and optimal management of the physical spaces for the layout configuration and solves the problems of surface consumption meaning storage space for semi-finished products.

Furtherly advantageous is the fact that, thanks to the in-line configuration, the dead times connected with the transfer of the fabric to other devices and the consequent times for the tooling of the device are eliminated and, consequently, an increase in the efficiency of the process is guaranteed.

Further advantages derive from the fact that the process of the invention allows to improve the quality of the fabric processed in printing by improving the textile properties such as, for example, the colour, the solidity, the tactile quality, the brilliance and the like.

A further advantage of the apparatus and of the process of the invention, linked to the in-line arrangement of the processing devices, is represented by the fact that it guarantees a reduction in the number of operators involved in the process and, consequently, leads to savings in terms of personnel costs and related production costs.

Although the invention has been described above with particular reference to an embodiment thereof given only as a non-limiting example, numerous modifications and alternatives will appear evident to one skilled in the art in the light of the above description. The present invention, therefore, intends to embrace all the modifications and alternatives that fall within the scope of the following claims.

1. A process for fabric treatment processing, characterized in that it comprises operating steps of printing a fabric, chemical finishing of the printed fabric (24), and drying/polymerization of the printed fabric, with said processing steps being implemented in-line with the fabric transiting according to a horizontal advancing direction at a fixed or variable or otherwise modulable speed.

2. The process according to claim 1, characterized in that the chemical finishing step takes place by means of application of chemical solution on the printed fabric according to a transverse development direction of the same fabric and with said application of chemical solution that takes place with the fabric during advancement for a uniform distribution of the chemical solution over the entire surface of the fabric.

3. The process according to claim 1, characterized in that the chemical finishing step takes place between the printing step and the drying/polymerization step or successively to the drying/polymerization step or during said drying/polymerization step.

4. The process according to claim 1, characterized in that the application of the chemical solution on the fabric is carried out by spraying and/or digital impregnation by means of heads.

5. The process according to claim 1, characterized in that the application of the chemical solution on the fabric is carried out by rolling or doctoring or by impregnation sizing.

6. An apparatus for fabric treatment processing according to the process of claim 1, characterized in that it comprises a printing device, a finishing device and a drying/polymerization device, with said devices being arranged in-line with a fabric transiting between said devices according to a horizontal advancing direction.

7. The apparatus according to claim 6, characterized in that the finishing device comprises a support structure supporting a base the transverse dimension of which corresponds to the transverse development dimension of the printing device and of the drying/polymerization device, said base housing a drawing-in roller rotatably arranged according to the transverse development direction of said base and functional for a sliding of a fabric, said base to which a pair of opposing and parallel shoulders is stabilized which support a crossbar which supports means for applying a chemical solution to said fabric in transit.

8. The apparatus according to claim 7, characterized in that the means for applying a chemical solution to the fabric comprise spraying elements and/or heads for digital impregnation arranged along the longitudinal development of the crossbar in one or more rows.

9. The apparatus according to claim 6, characterized in that the means for applying a chemical solution to the fabric comprise rollers or doctor blades or a sizing device with an impregnation tray.

10. The apparatus according to claim 6, characterized in that the finishing device is movable or fixed for its arrangement in an intermediate position between the printing device and the drying/polymerization device or within the drying/polymerization device or downstream of the drying/polymerization device.
